(19) United States
(12) Patent Application Publication
(10) Pub. No.: US 2018/0218421 A1
(43) Pub. Date: Aug. 2, 2018

(54) METHOD AND SYSTEM FOR PROVIDING CUSTOMIZABLE COSMETIC KIT

(71) Applicant: Mary Ershadi, Tarzana, CA (US)

(72) Inventor: Mary Ershadi, Tarzana, CA (US)

(21) Appl. No.: 15/419,676

(22) Filed: Jan. 30, 2017

(51) Int. Cl. G06Q 30/06; G06Q 50/22

(52) U.S. Cl. CPC G06Q 30/0621; G06Q 50/22

(57) ABSTRACT

The present disclosure relates to system and methods for providing customizable cosmetic kit. In accordance with one embodiment of the present disclosure, a system comprises an ordering unit that provides a user with a list of skin conditions which the user would like to receive treatment and allows the user to select at least one skin condition from the list; a processing unit that causes a cosmetic kit to be generated, wherein the cosmetic kit comprises: a cosmetic base and at least one active ingredient or booster that is effective in treating the at least one skin condition selected by the user; and a delivering unit which causes the cosmetic kit to be delivered to the user, wherein the cosmetic kit instructs the user to mix the cosmetic base and the active ingredient or the booster before using.

### CROSS-REFERENCE TO RELATED PATENT APPLICATIONS

Embodiments of the present invention relate to U.S. Provisional Application Ser. No. 62/289,035, filed Jan. 29, 2016, entitled “METHOD AND SYSTEM FOR PROVIDING CUSTOMIZABLE COSMETIC KIT”, the contents of which are incorporated by reference herein in its entirety and which is a basis for a claim of priority.

### FIELD OF THE DISCLOSURE

The present disclosure generally relates to systems and methods for providing customizable cosmetic kit. More specifically, the present disclosure discloses systems and methods that provide users with cosmetic kits that comprise active ingredient(s) and/or booster(s) that are effective in treating skin condition(s) selected by the users. Further, the active ingredient(s) and/or booster(s) are mixed by the users before their using to maximize and maintain the booster(s)′ freshness and effectiveness.

### BACKGROUND OF THE INVENTION

Undesirable skin conditions, ranging from visible scarring to acne to hypersensitivity, pigmentation and premature ageing, can all be addressed, controlled and eradicated with a good skin care regime such as receiving proper treatment. The evolution of skincare through the centuries has led to the development of many new technologies and products that offer more choice than ever before.

For example, serums, a skin care product with high concentrations of certain active ingredients have been very popular in the past few years. These ingredients include, but not limited to, hyaluronic acid (to reduce the appearance of lines and wrinkles), vitamin C (to brighten the skin and help reduce the appearance of pigmentation and age spots) and/or glycolic acid (an exfoliant) etc.

However, one of the shortcomings of conventional skincare product is that they are fixed in ingredient(s) and/or function(s) for each product. As such, for users that require multiple condition treatments, they need to use multiple brands of serums, making the skincare process inconvenient and perhaps expensive. In addition, most ingredients of conventional skincare product are mixed in advance, which might reduce the effectiveness of the skincare product due to chemical reaction between different ingredients over time.

The present disclosure solves the shortcomings of the conventional art by providing a customizable cosmetic kit that comprises a cosmetic base with at least one active ingredient and/or a booster depending on the skin condition(s) the users want to receive treatment. The customizable cosmetic kit also allows users to mix the cosmetic base, active ingredient(s) and/or boosters themselves prior to their using so they can make their own fresh cosmetic product.

### SUMMARY OF THE INVENTION

The embodiments of the present invention generally relate to systems and methods for providing customizable cosmetic kit. More specifically, the present disclosure provides users with cosmetic kits that comprise different active ingredient(s) and/or booster(s) base on the users' selection for skin treatment(s), and the selected active ingredient(s) and/or booster(s) are mixed by the users themselves before using to maximize and maintain the active ingredient(s) and/or booster(s)' freshness and effectiveness.

In accordance with one aspect of at least one embodiment of the present disclosure, a system for providing customizable cosmetic kit is provided. The system comprises: 1) an ordering unit that provides a user with a list of skin conditions which the user would like to receive treatment via a computer interface and allows the user to select at least one skin condition from the list via the computer interface; 2) a processing unit that causes a cosmetic kit to be generated, wherein the cosmetic kit comprises a cosmetic base and at least one active ingredient or booster that is effective in treating the skin condition(s) selected by the user; and 3) a delivering unit which causes the cosmetic kit to be delivered to the user, wherein the cosmetic kit instructs the user to mix the cosmetic base and the at least one active ingredient or booster before using.

In accordance with one aspect of yet another embodiment of the present disclosure, a method for providing customizable cosmetic kit is provided. The method comprises: 1) providing a user with a list of skin conditions which the user would like to receive treatment via a computer platform or interface; 2) allowing the user to select at least one skin condition from the list via the computer platform or interface; 3) generating a cosmetic kit that comprises a cosmetic base and at least one active ingredient or booster that is effective in treating the at least one skin condition selected by the user; 4) causing the cosmetic kit to be delivered to the user; and 5) instructing the user to mix the cosmetic base with the at least one active ingredient or booster before using.

These and other features, aspects and advantages of the present invention will become better understood with reference to the following drawings, description and claims.

### DETAILED DESCRIPTION OF THE PREFERRED EMBODIMENT(S) AND INVENTION

The following description is not to be taken in a limiting sense, but is made merely for the purpose of illustrating the general principles of the disclosure, since the scope of the disclosure is best defined by the following claims. Various inventive features are described below that can each be used independently of one another or in combination with other features.

Broadly, embodiments of the present disclosure generally relate to systems and methods for providing a cosmetic kit with customized ingredients based on the user's skin condition. In accordance with one embodiment of the present disclosure, a system for providing customizable cosmetic kit comprises: an ordering unit that allows a user to order and customize a cosmetic kit; a processing unit that causes the cosmetic kit to be generated based on the user's input; and a delivering unit which causes the cosmetic kit to be delivered to the user, wherein the cosmetic kit instructs the user to mix the cosmetic base, the active ingredient and the booster before using.

In one embodiment of the present disclosure, the ordering unit comprises a website (or a computer interface) that provides the user with a list of skin conditions in which the user would like to receive treatment for. Each skin condition listed is associated with at least one active ingredient and/or one booster that is/are effective in treating the skin condition. After the user selects skin condition(s) he or she would like to receive treatment for, the user's cosmetic kit will comprise at least active ingredient(s) and/or booster(s) that are effective in treating the skin condition(s) selected by the user.

Alternatively, after the user selects skin condition(s), the website may present to the user with a list of active ingredient(s) and/or booster(s) that are effective in treating the skin condition(s) selected by the user, and the user can select the active ingredient(s) and/or booster(s) the user would like to include from the list. This is particularly helpful when there is more than one type of active ingredient and/or booster that is effective in treating the skin condition(s) selected by the user. The skin conditions may include, but not limited to, wrinkles, discolorations, tightening, redness, dryness, firming, plumping, acne, pollution guard, vitamins+coq10 and cellular regeneration. Exemplary active ingredients may include, and not by way of limitation, Beautify™, Sculptessense™, Liftessense™, Matrixyl™, MDI™ and MultiEx™.

Optionally (or alternatively), the website can also provide descriptions of efficacy for each active ingredient and booster available for the cosmetic kit in treating a variety of skin conditions (e.g., description showing which booster(s) and/or active ingredient(s) is/are effective in treating a specific skin condition or conditions). Based on the descriptions, visitors of the website (e.g., the user) can simply select which active ingredient(s) and/or boosters they would like to include in their customized cosmetic kit.

In yet another embodiment of the present disclosure, the ordering unit may also allow the user to place the order through phone calls or physical forms (e.g., mail-in order). The user may select the skin condition(s) the user would like to receive treatment and/or specific active ingredient(s) and/or booster(s) from a catalog (online or physical booklet) and place the order through a phone or a physical order form without going through the website.

After the order is placed by the user, the ordering unit will send the order request to the processing unit, which will create a cosmetic kit, or cause a cosmetic kit to be created, that comprises a cosmetic base, and at least one active ingredient and/or booster that is effective in treating the skin condition(s) selected by the user (or comprises a cosmetic base and specific active ingredient and/or booster selected by the user). The kit would optionally contain a booklet which provides instructions on how to use the cosmetic kit, which at least instructs or teaches the user how to mix the ingredients and boosters to make fresh cosmetic product. To maximize the freshness of the cosmetic kit, the cosmetic kit can be delivered to the user with a cold pack.

The active ingredient and/or booster can be placed in plurality of vials. The amount of vials can be determined by the user or the processing unit depending on the user's skin condition and/or length of treatment required.

In one embodiment of the present disclosure, the cosmetic kit comprises a jar with a liquid or cream base (i.e., cosmetic base) that the user would put the vials of ingredient(s) and/or booster(s) in and mix them with the liquid or cream base. Optionally, there would then be another vial with a gel that the user could pour into the liquid or cream base and shake, making the mixed liquid or cream base, ingredient(s) and booster(s) to turn into a cream.

For example, and not by way of limitation, the liquid base may be formed by at least one of the following ingredients or combination thereof: Deionized Water, Aloe Vera Gel (humectant), Pentylene Glycol (water soluble emollient), Xanthan Gum/Pullulan Blend (stabilizer, texture modifier), Propanediol (water soluble emollient/humectant), Carbomer (viscosity modifier/stabilizer), Disodium EDTA (chelator, helps prevent oxidation, heavy metal contamination, and pH shifts), Sodium Hydroxide (pH adjusting alkaline), Caprylhydroxamic Acid (preservative) and Benzyl Alcohol (preservative). The cream base may be formed by at least one of the following ingredients or combination thereof: Deionized Water, Glycerin (Humectant), Xanthan Gum (stabilizer, texture modifier), Cetearyl Alcohol (fatty alcohol/thickener), Cetearyl Glucoside (emulsifier/thickener), Methyl Glucose Dioleate (emulsifier), Safflower Oil (emollient), Grapeseed Oil (emollient), Plant Squalane Oil (emollient), Disodium EDTA (chelator), Phenoxyethanol (preservative), Ethylhexylglycerin (preservative) and Citric Acid (pH adjusting acid).

In yet another embodiment of the present disclosure, a method for providing a customizable cosmetic kit is provided. The method comprises: providing a user with a list of skin conditions which the user would like to receive treatment or descriptions of efficacy for active ingredient(s) and/or booster(s) that are effective in treating a variety of skin conditions via a computer interface; allowing the user to select at least one skin condition, active ingredient or booster from the list via the computer interface; generating a cosmetic kit that comprises a cosmetic base and at least one active ingredient and/or booster that is effective in treating the skin condition(s) or specifically selected by the user; delivering the cosmetic kit to the user or cause the cosmetic kit to be delivered to the user; and instructing the user to mix the cosmetic base, the active ingredient and the booster before using. The skin conditions may include, but not limited to, wrinkles, discolorations, tightening, redness, dryness, firming, plumping, acne, pollution guard, vitamins+coq10 and cellular regeneration.

The active ingredient and/or booster can be placed in plurality of vials. The amount of vials can be determined by the user or the processing unit depending on the user's skin condition and/or length of treatment required.

As illustrated above, the cosmetic kit can be a jar with a liquid or cream base (i.e., cosmetic base) that the user would put the vials of ingredient(s) and/or booster(s) in. Optionally, there would then be another vial with a gel that the user could pour into the liquid base and shake, making the mixed liquid base, ingredient(s) and booster(s) to turn into a cream. The liquid base may be formed by at least one of the following ingredients or combination thereof: Deionized Water, Aloe Vera Gel (humectant), Pentylene Glycol (water soluble emollient), Xanthan Gum/Pullulan Blend (stabilizer, texture modifier), Propanediol (water soluble emollient/humectant), Carbomer (viscosity modifier/stabilizer), Disodium EDTA (chelator, helps prevent oxidation, heavy metal contamination, and pH shifts), Sodium Hydroxide (pH adjusting alkaline), Caprylhydroxamic Acid (preservative) and Benzyl Alcohol (preservative). The cream base may be formed by at least one of the following ingredients or combination thereof: Deionized Water, Glycerin (Humectant), Xanthan Gum (stabilizer, texture modifier), Cetearyl Alcohol (fatty alcohol/thickener), Cetearyl Glucoside (emulsifier/thickener), Methyl Glucose Dioleate (emulsifier), Safflower Oil (emollient), Grapeseed Oil (emollient), Plant Squalane Oil (emollient), Disodium EDTA (chelator), Phenoxyethanol (preservative), Ethylhexylglycerin (preservative) and Citric Acid (pH adjusting acid).

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A system for providing customizable cosmetic kit comprising:
an ordering unit that provides a user with a list of skin conditions which the user would like to receive treatment via a computer interface and allows the user to select at least one skin condition from the list via the computer interface;
a processing unit that causes a cosmetic kit to be generated, wherein the cosmetic kit comprises a cosmetic base and at least one active ingredient or booster that is effective in treating the at least one skin condition selected by the user; and
a delivering unit which causes the cosmetic kit to be delivered to the user, wherein the cosmetic kit instructs the user to mix the cosmetic base and the active ingredient or the booster before using.

2. The system of claim 1, wherein the ordering unit comprises a website that has descriptions of all types of active ingredients and boosters available.

3. The system of claim 1, wherein the list of skin conditions comprises wrinkles, discolorations, tightening, redness, dryness, firming, plumping, acne, pollution guard, vitamins+coq10 and cellular regeneration.

4. The system of claim 1, wherein the computer interface is displayed on a computing device.

5. The system of claim 1, where the booster comprises a plurality of vials.

6. The system of claim 1, wherein the cosmetic kit is delivered to the user with a cold pack.

7. The system of claim 1, wherein the cosmetic base is a liquid or cream in a jar that allows plurality of vials of active ingredient and booster to pour in.

8. The system of claim 7, wherein the liquid is formed by at least one ingredient selected from a list comprising Deionized Water, Aloe Vera Gel, Pentylene Glycol, Xanthan Gum/Pullulan Blend, Propanediol, Carbomer, Disodium EDTA, Sodium Hydroxide, Caprylhydroxamic Acid and Benzyl Alcohol.

9. The system of claim 7, wherein the cream is formed by at least one ingredient selected from a list comprising Deionized Water, Glycerin, Xanthan Gum, Cetearyl Alcohol, Cetearyl Glucoside, Methyl Glucose Dioleate, Safflower Oil, Grapeseed Oil, Plant Squalane Oil, Disodium EDTA, Phenoxyethanol, Ethylhexylglycerin and Citric Acid.

10. The system of claim 1, further comprises a gel that will turn mixture of the cosmetic base, the active ingredient and the booster into a cream.

11. A method for providing customizable cosmetic kit comprising:
providing a user with a list of skin conditions which the user would like to receive treatment via a computer interface;
allowing the user to select at least one skin condition from the list via the computer interface;
generating a cosmetic kit that comprises a cosmetic base and at least one active ingredient or booster that is effective in treating the at least one skin condition selected by the user;
delivering the cosmetic kit to the user or causing the cosmetic kit to be delivered to the user; and
instructing the user to mix the cosmetic base and the active ingredient or the booster before using.

12. The method of claim 11, wherein the list of skin conditions comprises wrinkles, discolorations, tightening, redness, dryness, firming, plumping, acne, pollution guard, vitamins+coq10 and cellular regeneration.

13. The method of claim 11, wherein the user selects the at least one skin condition online via a computer interface displaying a webpage.

14. The method of claim 11, where the booster comprises a plurality of vials.

15. The method of claim 11, wherein the cosmetic kit is delivered to the user with a cold pack.

16. The method of claim 11, wherein the cosmetic base is a liquid or cream in a jar that allows plurality of vials of active ingredient and booster to pour in.

17. The method of claim 16, wherein the liquid is formed by at least one ingredient selected from a list comprising Deionized Water, Aloe Vera Gel, Pentylene Glycol, Xanthan Gum/Pullulan Blend, Propanediol, Carbomer, Disodium EDTA, Sodium Hydroxide, Caprylhydroxamic Acid and Benzyl Alcohol.

18. The method of claim 16, wherein the cream is formed by at least one ingredient selected from a list comprising Deionized Water, Glycerin, Xanthan Gum, Cetearyl Alcohol, Cetearyl Glucoside, Methyl Glucose Dioleate, Safflower Oil, Grapeseed Oil, Plant Squalane Oil, Disodium EDTA, Phenoxyethanol, Ethylhexylglycerin and Citric Acid.

19. A system for providing customizable cosmetic kit comprising:
an ordering unit that provides descriptions for a plurality of active ingredients and boosters on their efficacy in treating specified skin condition and allows a user to place an order for at least one active ingredient and/or booster selected by the user via a website displayed by a computer interface;
a processing unit that causes a cosmetic kit to be generated based on the order received from the ordering unit, wherein the cosmetic kit comprises a cosmetic base and the least one active ingredient or booster selected by the user;
a delivering unit which causes the cosmetic kit to be delivered to the user, wherein the cosmetic kit instructs the user to mix the cosmetic base and the active ingredient or the booster before using;
wherein the descriptions for a plurality of active ingredients and boosters include descriptions for treating wrinkles, di scolorations, tightening, redness, dryness, firming, plumping, acne, pollution guard, vitamins+coq10 and cellular regeneration; and
wherein the cosmetic base is a liquid formed by at least one ingredient selected from a list comprising Deionized Water, Aloe Vera Gel, Pentylene Glycol, Xanthan Gum/Pullulan Blend, Propanediol, Carbomer, Disodium EDTA, Sodium Hydroxide, Caprylhydroxamic Acid and Benzyl Alcohol, or a cream formed by at least one ingredient selected from a list a list comprising Deionized Water, Glycerin, Xanthan Gum, Cetearyl Alcohol, Cetearyl Glucoside, Methyl Glucose Dioleate, Safflower Oil, Grapeseed Oil, Plant Squalane Oil, Disodium EDTA, Phenoxyethanol, Ethylhexylglycerin and Citric Acid.

20. The system of claim 17, wherein the cosmetic kit further comprises a gel that will turn mixture of the cosmetic base, the active ingredient and the booster into a cream.
